(19) United States
(12) Patent Application Publication
(10) Pub. No.: US 2014/0203474 A1
(43) Pub. Date: Jul. 24, 2014

(54) DEVICE FOR COATING ELECTRICALLY CONDUCTIVE WIRES

(71) Applicants: Hubert Ludorf, Luebbecke (DE); Horst Neddermann, Rahden (DE)

(72) Inventors: Hubert Ludorf, Luebbecke (DE); Horst Neddermann, Rahden (DE)

(73) Assignee: AUMANN GMBH, Espelkamp (DE)

(21) Appl. No.: 14/237,493

(22) PCT Filed: Aug. 7, 2012
(86) PCT No.: PCT/EP2012/065437

§ 371 Date: Mar. 13, 2014

(30) Foreign Application Priority Data
Aug. 19, 2011 (DE) 10 2011 052 520.3

(51) Int. Cl. H01B 13/14

(52) U.S. Cl. CPC H01B 13/145
USPC 264/211.12; 425/113

(57) ABSTRACT

The present invention relates to a device for coating electrically conductive wires, comprising multiple units in the following arrangement:
a unit (1) for feeding in the wires,
a unit (2) for the pretreatment of the wires,
a unit (5) for applying a coating agent,
a unit (6) for the post-treatment of the coated wires,
a unit (8) for winding up the coated wire.

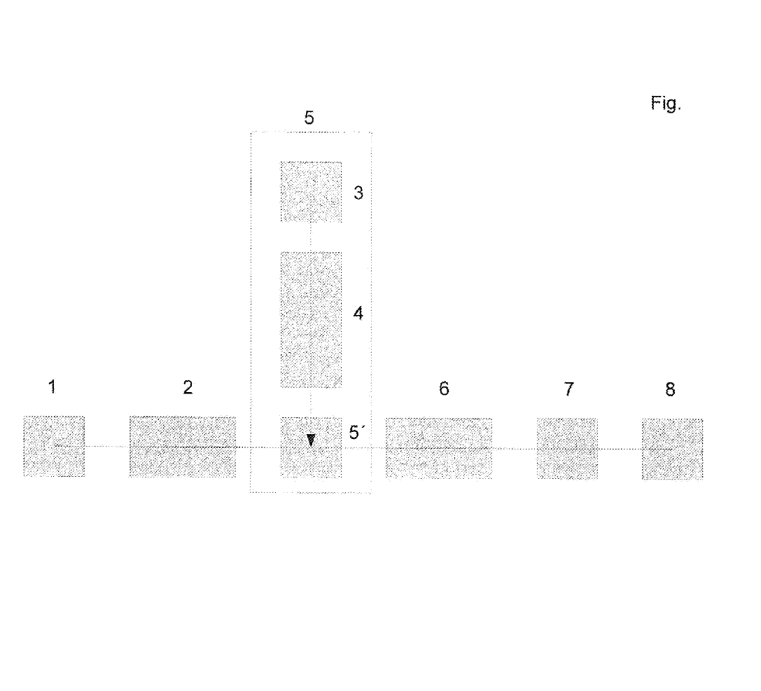

The present invention relates to a device and a method for applying one or more layers of a coating agent to electrically conductive wires.

According to the prior art, winding wires for electrical coils are particularly provided with coatings with an insulating effect. For example, for this purpose wire enamel is applied to the wires and hardened. This step may be repeated between one and over 30 times in order to ensure a flawless insulation. After that, the finished-coated wire is wound up onto a reel.

Devices for carrying out the method are described in the prior art, for example in DE 37 41 328 C2, EP 196017 B1 and WO 2005/082548 A2.

The previously known coating methods have in common that, before the coating, the wire can be soft- annealed in what is known as an annealer and freed of remains of drawing compound. After that, the enamel is applied either by a stripping die, or a felt. After that, the enamel is hardened in an oven. In order to minimize the escape of solvent vapors from the oven, the oven may be operated under a slight vacuum. Depending on the type of construction, the temperature in the oven is between 400 and 700° C. The residence time of the wire in the oven depends on the diameter of the wire and the desired application thickness for the coating agent. During the treatment in the oven, solvent is vaporized and the wire enamel resin is crosslinked. An insoluble film with good adhesion is produced. The evaporated solvent can be largely burned by means of a catalyst. The heat produced by the exothermic process can in turn be used for heating the oven.

For carrying out the method described, in WO 2005/082548 A2 a device with a transporting path for the wire material to be continuously transported through is provided. For the multiple coating, it is proposed to combine a heatable thermosetting station for the thermosetting of a solvent-containing enamel layer with a UV curing station, arranged upstream or downstream of the thermosetting station, for the UV radiation curing of the layer of enamel applied to the sheet material.

WO 2007/051458 A1 discloses a device that is equipped with an insulating enamel shaft through which the electrically conductive wire is transported by a conveying means. The insulating enamel shaft is provided on the input side with an enamel application unit, which is connected to a receptacle for the enamel. The thermal energy necessary for baking the insulating enamel is generated by a central heating unit, the hot air being directed through the insulating enamel shaft counter to the direction of conveyance of the wire and made to circulate by means of a fan. The device described is also equipped with an enamel shaft which is arranged parallel to the insulating enamel shaft and to which a partial stream of the hot air flow means distributor can be fed as required.

The device concerned is also described in EP 1961017 B1.

DE 37 41 328 A1 further discloses a device in which a system of pipes for the circulation of hot air is provided. Provided in the system of pipes are a fan for maintaining the circulation of hot air and openings in the system of pipes for feeding in fresh air and the hot air free of exhaust gas.

The methods and devices described are in need of improvement in energy-related respects. This is so because about 20% of the energy is lost through the radiation from the oven. Another 20% or so is lost through the flue air emitted from the chimney. The wire, which each time has to be treated as well, uses up about 55% of the energy from the enameling installation. The remaining 5% or so is used for hardening the enamel. These values may vary depending on the structural design of the installation.

In view of this, there have been attempts to increase the efficiency of wire enameling. None of the developments so far has made it to the state of being ready for the market.

An example of an increase in efficiency is described in DE 4336385 A1. The method described there leads to a thicker layer structure, with the result that only restricted application of the wires in transformer construction is possible. The high slot filling factor required in motor construction cannot be achieved by this method.

A further disadvantage of the wire produced by the method described is the low heat resistance of normally only 120° C., due to the use of thermoplastics. Consequently, such wires cannot be used for modern applications in coil and motor construction. This is so because these applications require resistance to temperatures of over 155° C. The beginning and end wires of coils are in most cases soldered or welded. When using the wires produced by the method described, both methods lead to problems on account of the high proportion of insulating material. This is because it evaporates during the soldering or welding, with the result that the quality of the connection is generally insufficient.

The object of the present invention is therefore to allow a device for applying a insulating coating to electrically conductive wires that no longer has the disadvantages described. The wires produced should correspond in their profile of properties at least to the commercially available standard wires, with the result that there is no need for any new certification. The device should operate energy-efficiently. Exhaust air that needs disposal or treatment should not occur.

This object is achieved by a device for coating electrically conductive wires that comprises multiple units, for example in the following arrangement:
a unit for feeding in the wires,
a unit for the pretreatment of the wires,
a unit for applying a coating agent,
a unit for the post-treatment of coated wires,
a unit for winding up the coated wire.

The unit for feeding in the wires is known in its configuration to a person skilled in the art from the prior art, for example wire pay-off systems in which
the wire is drawn from a reel, to be precise by the drawing force of a downstream unit, for example of the take-up;
the reel is set up vertically or at an angle and the wire is fed to the following units via deflecting rollers (a mechanical or electronic wire-tension controlling system may be connected downstream of these devices, with the result that the wire tensioning is controlled during the winding);
for thicker wires, the reel is driven by motor, in order in combination with a wire-tension controlling system to keep the wire tensioning low and constant.
   There are various designs of wire pay-off systems in the prior art for wire enameling and extruding installations.

The unit for the pretreatment of the wires is likewise known from conventional enameling machines. This may for example be what is known as an annealer. This annealer is used for soft-annealing the wire and freeing it of remains of drawing compound.

There may also be a preheating path, in which the wire is for example heated inductively.

The unit for applying the coating agent may be configured according to the coating agent to be used. The coating agents are selected such that they are suitable for the insulation of the wires. Thermoplastics may preferably be used. Thermoplastics that can be used are described for example in EP 0030717.

One possibility for applying the thermoplastics is to use extruders. In other words, the coating material is fed into the extruder via a storage container. The material is then applied from the extruder onto the wire. For this, the extruder expediently has a head unit, which is arranged downstream of the pretreatment unit. The extruder is preferably designed such that it is connected directly to the head unit (referred to hereinafter as the crosshead die) in such a way that the wire to be coated can be passed through the head unit. The extruder is adapted to the diameter of the wire and to the amount of insulating material to be applied (i.e. the amount of coating).

Granules or pellets of plastic for example are fed into the extruder from a storage container. In the extruder, the material is melted and finally applied to the pretreated wire in the crosshead die head.

Thermoplastics do not meet the requirements for modern wire enamels and enameled wires. Therefore, the device according to the invention is equipped with a unit for posttreating the coated wires. This post-treatment unit is preferably a unit in which the crosslinking of thermoplastic takes place. In other words, the applied thermoplastic is post-crosslinked and thus transformed into a thermoset. As a result, a profile of properties that is comparable to that of conventionally produced enameled wires is achieved.

The device for the post-crosslinking may operate by various commonly used methods. For example, crosslinking may take place by means of heat in an oven. Similarly, however, post-crosslinking is also possible by radiation. In other words, curing may take place by means of IR, NIR, UV or electron radiation. Similarly, other commonly used forms of high-energy radiation or else heating devices can also be used. The type of crosslinking method that is used depends on the thermoplastic that is respectively used. UV or NIR forms of radiation are particularly preferred.

If there is a development of heat during the post-crosslinking, or the coated wire becomes hot, a cooling path may be provided. This may be operated for example with cooling air or other media.

The installation described has considerable advantages over the prior art. Thus, with this installation, thermoplastics can be applied to electrically conductive wires (for example those known as enameled or winding wires) that meet modern requirements, in particular for heat resistance. The overall production of the coated wires is simpler than is possible with conventional enameling devices or methods, with which generally only one application method is used. Also, no unacceptable emissions occur. In addition, the energy consumption per kilogram of produced coated wire is much lower than previously. The installation also requires less space overall than was previously known according to the prior art. The previously known electrical and mechanical parameters apply to these wires, with the result that there is no need for any new certification. On account of the lower number of process parameters in comparison with the prior art, greater reliability of the process is also ensured.

The invention is described in more detail below with reference to the figure:

The feeding of the wires to be coated takes place by way of a unit 1. The bare wire is transferred into the unit 2, where the wire is pretreated. The pretreated wire is then passed through the unit 5. In this unit, the application of the insulating coating material takes place.

The unit 5 is configured as what is known as a crosshead die. This is connected to the extruder 4. In the extruder 4, granules or pellets of plastic coming from the storage container 3 are melted. The melted granules or pellets of plastic are then applied uniformly to the wire by way of the crosshead die.

The crosshead die 5 consists of the connecting part to the extruder outlet, the wire-guiding system, which is arranged centrally perpendicular or at an angle to the axis of the extruder screw.

The material is applied to the wire by means of distribution channels and a die guide around the wire guiding system.

The distribution channels are designed such that the material is distributed uniformly in a ring around the central wire passage and the coating takes place centrally.

This presupposes a constant delivery of extrudate, which is ensured by the predetermined extruder process parameters.

These parameters are predetermined by the respective diameter of the wire, coating thicknesses, production rates and materials.

The essential parameters are in this case the temperature profile over the length of the extruder barrel, the screw speed, the temperature of the crosshead die and the types of material. Furthermore, the coating thickness may also be controlled by the speed of the wire.

The coated wire is fed to the unit 6. In this unit, the crosslinking of the coating takes place. After that, cooling takes place by way of the unit 7. In the unit 8, the production of the end product takes place by winding up the wire.

1-10. (canceled)

11. A device for coating an electrically conductive wire, wherein the unit comprises in the following order:
(i) a unit for feeding the wire to be coated;
(ii) a unit for pretreating the wire to be coated;
(iii) a unit for applying a coating agent to the wire to be coated;
(iv) a unit for post-treating the coated wire of (iii), which unit is a crosslinking unit;
(v) a unit for winding up the post-treated coated wire;
the coating agent being a thermoplastic material.

12. The device of claim 11, wherein unit (ii) comprises a device for heating the wires.

13. The device of claim 11, wherein unit (i) is a preheating path.

14. The device of claim 12, wherein unit (i) is a preheating path.

15. The device of claim 11, wherein unit (iii) comprises an extruder, a storage container for feeding in coating agent, and a head unit which is arranged between unit (ii) and unit (iv) and through which wire to be coated is to be passed.

16. The device of claim 12, wherein unit (iii) comprises an extruder, a storage container for feeding in coating agent, and a head unit which is arranged between unit (ii) and unit (iv) and through which wire to be coated is to be passed.

17. The device of claim 13, wherein unit (iii) comprises an extruder, a storage container for feeding in coating agent, and a head unit which is arranged between unit (ii) and unit (iv) and through which wire to be coated is to be passed.

18. The device of claim 11, wherein unit (iv) is capable of effecting crosslinking by heat or high-energy radiation.

19. The device of claim 12, wherein unit (iv) is capable of effecting crosslinking by heat or high-energy radiation.

20. The device of claim 13, wherein unit (iv) is capable of effecting crosslinking by heat or high-energy radiation.

21. The device of claim 15, wherein unit (iv) is capable of effecting crosslinking by heat or high-energy radiation.

22. The device of claim 11, wherein the device further comprises a cooling device arranged downstream of unit (iv).

23. The device of claim 12, wherein the device further comprises a cooling device arranged downstream of unit (iv).

24. The device of claim 13, wherein the device further comprises a cooling device arranged downstream of unit (iv).

25. The device of claim 15, wherein the device further comprises a cooling device arranged downstream of unit (iv).

26. The device of claim 16, wherein the device further comprises a cooling device arranged downstream of unit (iv).

27. The device of claim 21, wherein the device further comprises a cooling device arranged downstream of unit (iv).

28. A method for coating an electrically conductive wire, wherein the method comprises feeding wire to be coated via a feeding unit to a unit for pretreating the wire, applying coating agent to the pretreated wire from an extruder of a coating unit, followed by treating coated wire in a post-treatment unit and thereafter winding up post-treated wire, the post-treatment unit being a crosslinking unit and the coating agent being a thermoplastic material.

29. The method of claim 28, wherein granules from a storage container are fed to the extruder, from which melted coating agent is passed into a unit for coating the wire.

30. The method of claim 28, wherein following a crosslinking of the wire in the post-treatment unit, the wire is cooled in a cooling unit.
